(19) United States
(12) Patent Application Publication
(10) Pub. No.: US 2009/0204636 A1
(43) Pub. Date: Aug. 13, 2009

(54) MULTIMODAL OBJECT DE-DUPLICATION

(75) Inventors: Jin Li, Sammamish, WA (US); Li-wei He, Redmond, WA (US); Sudipta Sengupta, Redmond, WA (US); Amitanand Aiyer, Austin, TX (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/028,840

(22) Filed: Feb. 11, 2008

(51) Int. Cl. G06F 17/30

(52) U.S. Cl. 707/103 Y; 707/E17.001

(57) ABSTRACT

Various object de-duplication techniques may be applied to object systems (such as to files in a file store) to identify similar or identical objects or portions thereof, so that duplicate objects or object portions may be associated with one copy, and the duplicate copies may be removed. However, an object de-duplication technique that is suitable for de-duplicating one type of object may be inefficient for de-duplicating another type of object; e.g., a de-duplication method that significantly condenses sets of small objects may achieve very little condensation among sets of large objects, and vice versa. A multimodal approach to object de-duplication may be devised that analyzes an object to be stored and chooses a de-duplication technique that is likely to be effective for storing the object. The object index may be configured to support several de-duplication schemes for indexing and storing many types of objects in a space-economizing manner.

### BACKGROUND

Many computing scenarios involve the storage of objects in an object system according to physical locations on various memory devices, and the exposure of such objects to a user according to logical organization schemes. For example, a computer system may logically represent a collection of files as grouped together in a hierarchical file system, but the files may be physically stored as one or more segments in various sectors of a platter of a hard disk drive. The computer system may opaquely manage the storage of the objects on the physical media, and may provide hardware and software management routines to handle related technical issues (e.g., object fragmentation, media defragmentation, error detection and correction for media failures, accessor procedures for reduced access latency and improved streaming consistency, RAID schemes, hardware-level encryption and decryption, etc.) in the background while maintaining the logical organization of the objects.

An object system may relate the physical locations of the objects in memory to the logical system according to an object index. As one example, an object index might comprise a list of the name and logical location (e.g., a file system path) of each object, along with a starting address on a physical medium and the size of the object, represented as the number of contiguous words of the physical medium comprising the object. Moreover, in order to reduce the redundant storage of data, a computer system may be configured to map two or more logically identical objects (i.e., two or more objects having the same size and bit-for-bit contents) to one physical location. For instance, when an object is stored to the object system, the object system may detect whether an identical copy of the object already exists in the object system; if so, instead of storing a second copy of the object, the object system may store in the object index a second logical reference to the physical location of the duplicate object. This mapping technique avoids the duplicate storage of two or more identical copies of the object, thereby conserving space utilization of the physical medium.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The manner of storing and indexing objects in an object system may be adjusted in many ways to reduce the storage of duplicate copies of data (sometimes referred to as “de-duplication” of objects) based on the kinds of data. For example, if the object system comprises many small objects, then the characteristics of an object to be stored may be compared with characteristics of other objects to detect and circumvent duplicate object storage. This may be accomplished, e.g., by computing a hashcode for each object with a single hash function and storing the hashcodes in a hashtable. When a new object is to be stored, its hashcode may be computed and compared with the hashcodes of already stored objects, and if a matching hashcode is found in the hashtable, the associated object may be considered a duplicate of the new object.

However, other techniques may be well-suited for other kinds of data. As one example, two large objects may be very similar, perhaps comprising only a single bit difference in a large body of data, yet the single difference will prevent duplicate detection according to this hashcode indexing scheme. Instead, it may be feasible to compute the difference between the two objects, and to store the first object as a reference to the second object plus a data delta that describes the differences between the two objects (i.e., how to realize the contents of the first object in view of the second object and the changes thereto.) Moreover, the comparisons and differencing of the objects may be differently configured based on whether the structure of the objects is known (e.g., records in a flat database structure, or email messages in an email archive) or unknown (e.g., two arbitrary sets of binary data with no discernible structure.) Moreover, a technique that is helpful for efficiently storing and indexing one type of data may be not just unhelpful, but even less efficient, for storing and indexing another type of data. For instance, if a differencing comparison and storage technique is applied to small objects, the amount of data storage consumed thereby (and the amount of computing cycles to manage the data in view of changes) may be even more expensive than simply storing the small objects without any kind of de-duplication.

Instead, a multimodal approach to data de-duplication may be applied, wherein different types of objects are analyzed to determine some characteristics, and one of several storage techniques is selected to store and index the data in an efficient manner. For example, a data size threshold may be chosen or computed, such that objects smaller than the data size threshold are stored according to a whole-object de-duplication technique, and objects not smaller than the data size threshold are stored according to an object differencing de-duplication technique. Moreover, the latter class of objects may be stored differently depending on whether the structure of the large object can be determined (such that different portions of the object structure may be de-duplicated by referencing portions of equivalent object structures in other objects) or is unknown (such that heuristics may be applied to section the object into chunks that may be equivalent to chunks in other objects.) A multimodal approach to object storage and indexing may therefore orient various de-duplication techniques with more fitting respect to the nature of the objects stored thereby.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of storing an object in an object system.

FIG. 2 is a component block diagram illustrating an exemplary system for storing objects in an object system prior to the storage of a set of objects depicting the state of the computing environment prior to the storage of a set of objects.

FIG. 3 is a component block diagram illustrating the exemplary system for storing objects in the object system illustrated in FIG. 2, depicting the state of the computing environment after the storage of a set of objects.

FIG. 4 is a flow diagram illustrating an exemplary method of storing objects in an object system according to an object de-duplication method.

FIG. 5 is a component block diagram illustrating an exemplary bidirectional object index for use in an object system.

FIG. 6 is a flow diagram illustrating an exemplary method of storing objects in an object system according to an object segment de-duplication method.

FIG. 7 is a component block diagram illustrating an association of a logical object index for objects comprising segments and a physical segment set.

FIG. 8 is a component block diagram illustrating an association of a logical object index for objects comprising segments, a logical segment index, and a physical segment set.

FIG. 9 is a component block diagram illustrating an association of another logical object index for objects comprising segments, a logical segment index, and a physical segment set.

FIG. 10 is a flow diagram illustrating an exemplary method of storing objects in an object system according to an object chunk de-duplication method.

FIG. 11 is a flow diagram illustrating an exemplary method of identifying fingerprints in an object for use in an object chunk de-duplication method.

FIG. 12 is an exemplary application of a method of identifying fingerprints in an object to the contents of an object.

FIG. 13 is a flow diagram illustrating an exemplary method of computing a trait set for an object comprising one or more traits.

FIG. 14 is an exemplary application of a method of computing a trait for an object to the contents of an object.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Object storage systems may be configured to store objects in many ways and for many purposes. As one example, objects to be randomly accessed and updated in arbitrary order may be advantageously stored in a scattered manner to allocate some room for relocation and growth, while objects to be accessed in a read-only and sequential manner my be advantageously stored as a contiguous series. Moreover, such objects may be indexed in various manners, where respective index records map an object having a logical reference (such as an identifying name) to an addressable location on physical media (such as memory chips, hard disk drives, and transferable media) containing the data. Such indices may also reference several addressable locations, such as redundant copies of an object stored on multiple devices in a RAID 0 array for faster availability and/or backup protection, or multiple locations on a device storing sections of a fragmented object.

Despite considerable and steady gains in the capacity of storage devices (both per dollar and per volumetric unit), economy of data storage remains a significant issue. For example, large corporations may provide many terabytes of server space for users, but such users may generate gigabytes of new data per day. Moreover, in such environments, an object may be replicated many times (e.g., a company-wide mass email sent to thousands of employees), and may contain many objects that differ only slightly (e.g., a Word document comprising a form, and many copies of the form filled in with a few pieces of information.) De-duplication techniques may therefore conserve a significant amount of data in a very large store of objects, and may provide considerable cost and space savings for large stores of objects. Such techniques may be difficult to apply to scenarios involving dynamic objects, such as the files of a file system in frequent flux, because a change of one object may involve adjustments to the storage of many objects that reference the changing object in whole or in part for de-duplication. However, de-duplication techniques may be advantageous in scenarios involving predominantly static objects, such as data warehouses or backup archives, where space conservation is of considerable interest and objects are unlikely to change often.

Many de-duplication techniques may be available for detecting identical or similar data, and for storing references to such data. A first de-duplication technique may attempt to identify objects according to a property, such as a hashcode computed with a hash function and stored in a hashtable associated with the object index. When a new object is provided for storage, the computer system may compute its hashcode and consult the hashtable to determine if another object having the same hashcode is already stored. If so, the computer system may forego storing a duplicate copy of the object, and may instead store the object as a second reference to the copy of the object already stored and indexed. This technique may be useful for storing many small and discretely stored objects (e.g., objects comprising individual email messages), where many small objects may be identical to many other small objects. This technique does not detect minor variations among objects—e.g., two objects that differ only by one bit—but the inefficiency in not accounting for such minor variations may be offset by the speed and comparative simplicity of this de-duplication technique.

A second technique may be devised for large objects of a discernible structure, wherein some portions of the object may identically exist as portions of other objects. For example, a large object may contain a series of segments of a particular structure, such as an email archive containing a large number of email messages or a database containing many database records. Moreover, a particular segment may be present in identical form in a large number of the objects, such as a mass institution-wide email sent to thousands of employees, and stored as a copy in the email archives of respective employees. If the segments of an object may be determined according to the structure of the object, the segments can be indexed (e.g., according to a hashcode computation stored in a hashtable associated with the segment index), and de-duplication may be performed among the segments of the large objects.

A third technique may be devised that is advantageous for storing and indexing large objects of unknown structure that may be closely similar to other objects, but may not be identical. In this technique, a small information set may be generated for respective objects that describes the contents of each object, which may be compared on a bit-for-bit basis as a similarity measurement. The small information set for a new object may be compared against the information sets for existing object to determine whether a closely similar object exists in the object storage system. If so, the new object may be stored not as a nearly identical duplicate, but as a reference to the closely similar object and a record of the differences between the two objects (comprising a data delta.) The data delta may be applied to the stored object to determine the contents of the de-duplicated object of close similarity. In this manner, a comparatively large object of indeterminate structure may be effectively de-duplicated, and the inefficiency of storing multiple copies of large and very similar objects may be reduced.

These three techniques may be more advantageous for application to one type of object than to another type of object. For example, object-based de-duplication may be advantageous for small objects, but may be less useful for large objects, which may less often be stored as identical copies. For example, two MP3 recordings may contain several megabytes of identical data comprising the same music recording, but may differ in tag information stored with the MP3 to identify the name of the artist and the album from which the MP3 recording was captured. Thus, applying this de-duplication technique to such larger objects may present minimal space economization, and may fail to detect many objects that are very similar. Conversely, similarity-based de-duplication may be more advantageous than the other techniques for de-duplicating large objects of unknown structure, but may be less efficient for storing small objects, because the computing resources consumed in performing the complex comparison and indexing techniques may yield little advantage in space savings. Moreover, it may be difficult to choose one storage and indexing technique that provides efficient de-duplication for an object set comprising many types of objects (including small objects, large objects having a structure, and large objects of unidentifiable structure.)

As an alternative, objects may be stored according to any of these techniques, depending on the characteristics of the object. Object indexing and storing may be adapted to utilize different techniques for storing small objects, for storing large objects with structure, and for storing large objects without structure. Small objects may be stored according to an object de-duplication method, which endeavors to find a previously stored object of equal contents and to index the new object to the stored object. Large objects with structure may be stored according to an object segment de-duplication method, which endeavors to identify, for each segment of the object, an identical segment in a previously stored object and to index the segment to the stored segment. Large objects without structure may be stored according to an object chunk de-duplication method, which endeavors to identify a previously stored object that is similar to the object, and to index the object as a reference to the similar object and a data delta indicating the differences between the objects. The computer system implementing these techniques may therefore receive and store any object according to an efficient de-duplication method, and may support all three methods while storing and indexing the objects. For example, an object index in such a computer system may associate each stored block of data with a hashcode for computing equality comparisons with respect to small objects, a segment hashcode for computing equality comparisons with segments of large objects having structures, and/or a signature set for computing similarity comparisons with chunks of large objects not having discernible structures. Upon receiving an object to be stored, the computer system may choose a storage and indexing technique based on the characteristics of the new object, such as its size and structure. The object may then be stored according to the de-duplication technique likely to provide an advantageous economization of storage space in view of the nature of the object. The system may also retrieve a stored object by determining which de-duplication method was used to store the object, and may reassemble the object based on the manner in which the object was indexed (e.g., by retrieving a data delta and applying it to a referenced object to derive the contents of the object of interest.) In this manner, an implementation of the techniques discussed herein may apply a multimodal approach to de-duplication, and may be configured to support the details of the multiple modalities embodied thereby.

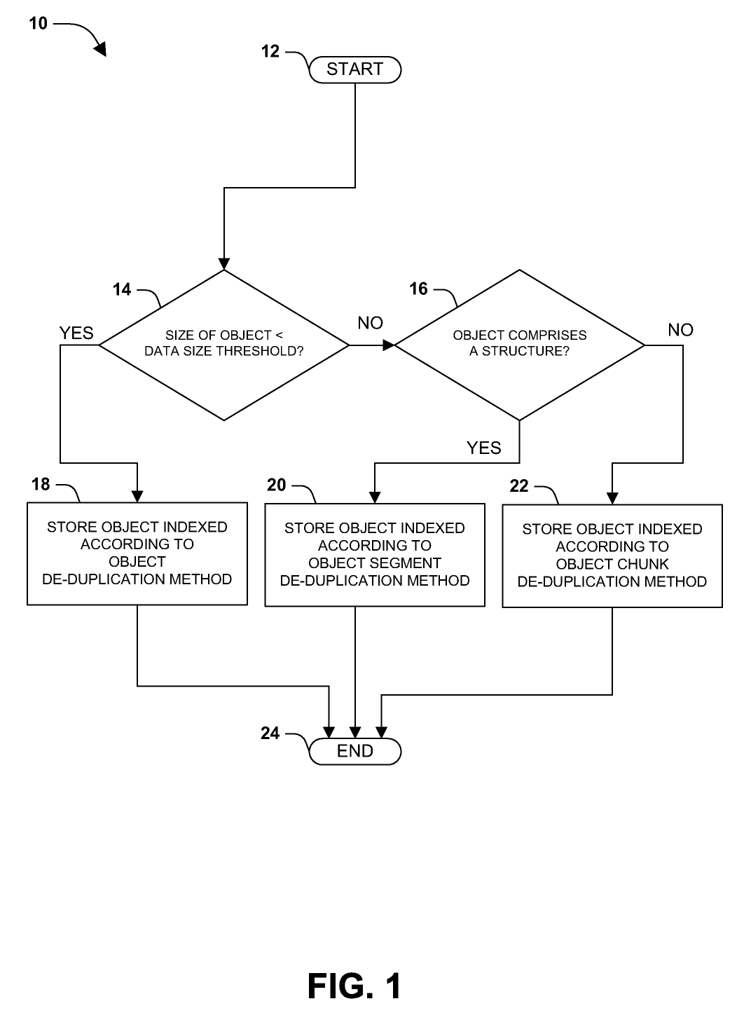

FIG. 1 illustrates one embodiment of these techniques, comprising an exemplary method 10 of storing an object of an object system having an object index. The exemplary method 10 of FIG. 1 begins at 12 and involves comparing 14 the size of the object to a data size threshold, which may be chosen to distinguish between small and large objects. The data size threshold may be chosen to differentiate small objects from large objects in order to store and index the objects according to a more advantageous de-duplication technique, as discussed herein. The data size threshold may be chosen and specified arbitrarily, or may be computationally selected (e.g., through heuristics or trial-and-error testing.) If the size of the object is below the data size threshold, the exemplary method 10 branches after the comparing 14 and involves storing 18 the object in the object system indexed according to an object de-duplication method. However, if the size of the object is not below the data size threshold, the exemplary method 10 involves determining 16 whether the object comprises a structure. If the object comprises a structure, then the exemplary method 10 branches at 16 and involves storing 20 the object in the object system indexed according to an object segment de-duplication method. If the object does not comprise a structure, then the exemplary method 10 also branches at 16 and involves storing 22 the object in the object system indexed according to an object chunk de-duplication method. By storing the object in the object system indexed according to one of an object de-duplication method, an object segment de-duplication method, and an object chunk de-duplication method, the exemplary method 10 achieves the storage of the object according to a de-duplication method likely to achieve an advantageous economization of storage space, and so the exemplary method 10 ends at 24.

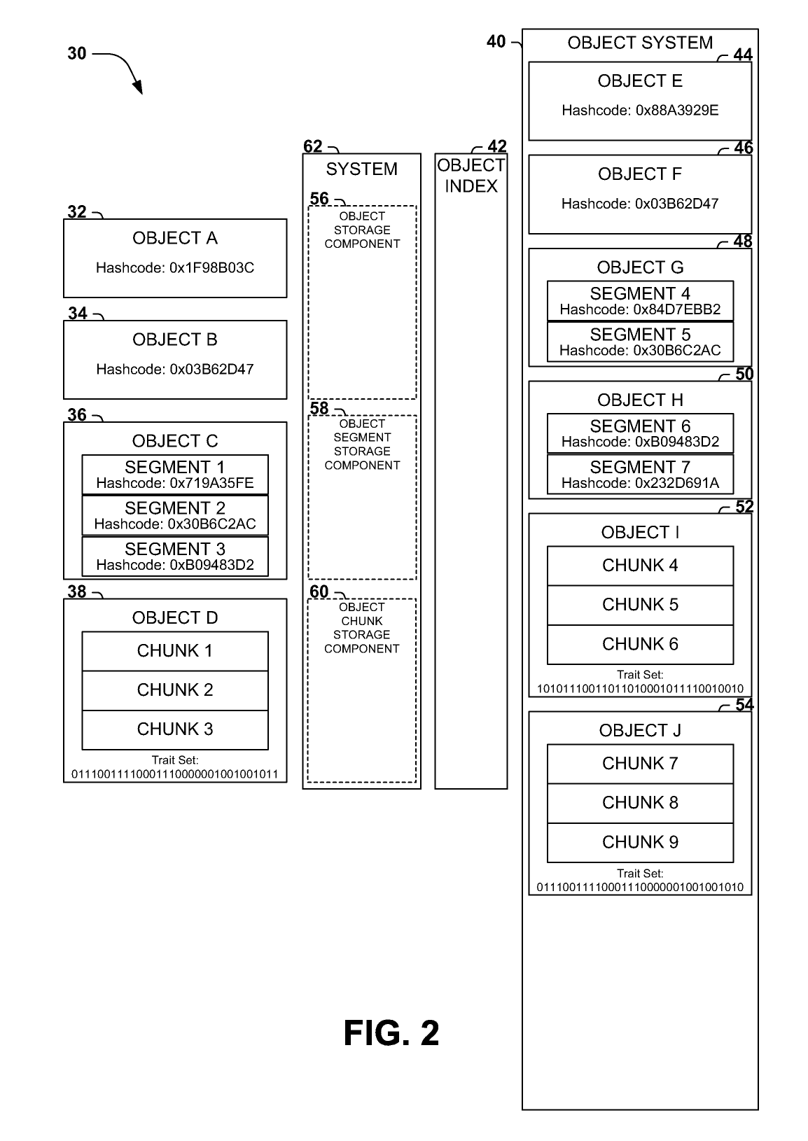

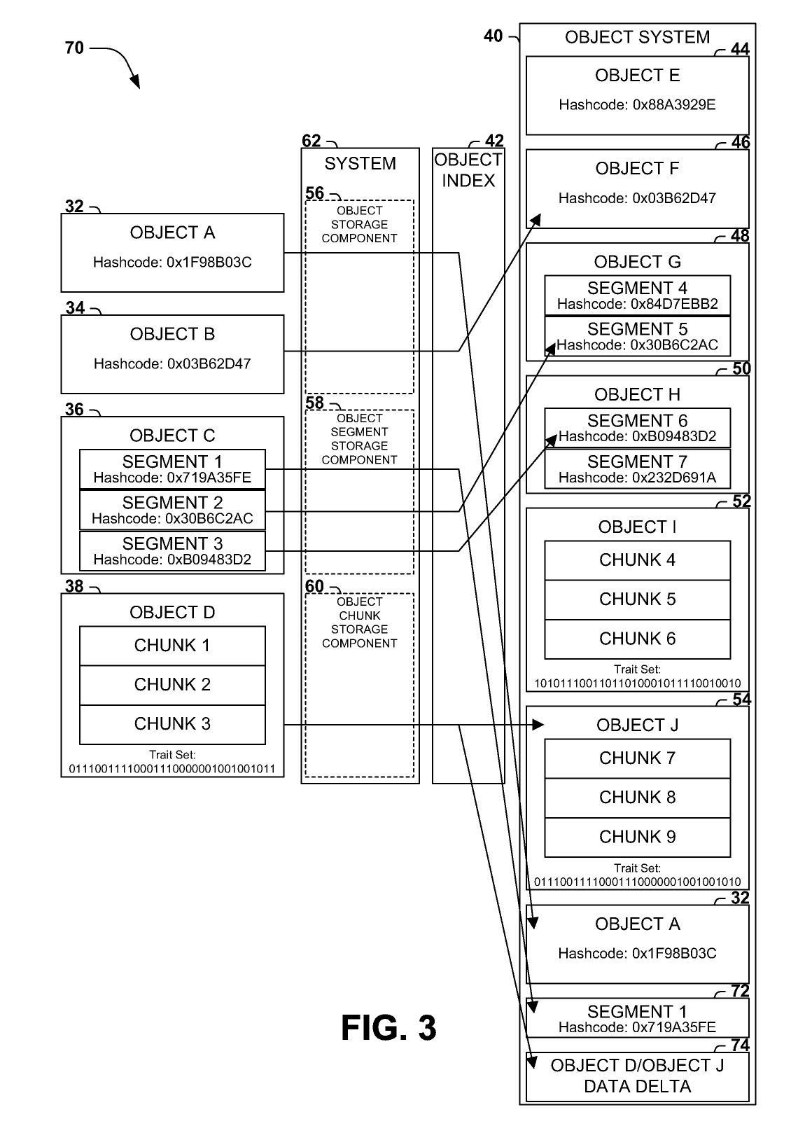

FIGS. 2-3 together presents another embodiment of these techniques, illustrated as an exemplary system 62 for storing an object of an object system 40 having an object index 42. The exemplary system 62 comprises an object storage component 56 configured to store objects having a size below a data size threshold in the object system 40 indexed according to an object de-duplication method; an object segment storage component 58 configured to store objects having structure and having a size not below a data size threshold in the object system 40 indexed according to an object segment de-duplication method; and an object chunk storage component 60 configured to store objects of unidentifiable structure and having a size not below the data size threshold in the object system 40 indexed according to an object chunk de-duplication method. Again, the data size threshold may be chosen and specified arbitrarily, or may be computationally selected (e.g., through heuristics or trial-and-error testing.) The relative sizes of the objects illustrated in FIGS. 2-3 qualitatively suggest the sizes of the objects.

FIG. 2 illustrates a first state 30, wherein several new objects are provided to the exemplary system 62 for storage in the object system 40 and indexing in the object index 42. Four new objects are provided: Object A 32 and Object B 34, each comprising a small object (i.e., objects less than the data size threshold utilized by the exemplary system 62 for differentiating small and large objects); Object C 36, comprising a large object with a structure; and Object D 38, comprising a large object with unidentifiable structure. The first state 30 features an object system 40 containing several objects: Object E 44 and Object F 46, each representing a small object; Object G 48 and Object H 50, each representing a large object having structure; and Object I 52 and Object J 54, each representing a large object of unidentifiable structure. This first state 30 is presented to illustrate the state of the computer system (and in particular, the object system 40 and the object index 42) prior to storing any of the new objects. It may be appreciated that although the object system 40 is illustrated with some spare memory space, the available memory space would not be sufficient to store a copy of each of the new objects in their entirety.

FIG. 3 illustrates a second state 70, wherein the exemplary system 62 has performed the storage and indexing of the objects according to the techniques discussed herein. Object A 32 is received by the exemplary system 62 and analyzed to determine which de-duplication technique to use for storage and indexing. Because Object A 32 is small (according to a comparison of the size of Object A 32 to the predetermined data size threshold), Object A 32 is routed through the object storage component 56 of the exemplary system 62. The object storage component 56 processes Object A 32 according to an object de-duplication storage and indexing method. In this example, the object storage component 56 computes the hashcode of Object A 32 and compares the hashcode (0x1F98B03C) to the hashcodes of other objects stored in the object system 40. This comparison may be achieved (e.g.) by reference to a hashtable associated with the object index 42 that is configured to store the hashcodes of objects stored in the object system 40. The object storage component 56 finds no object having an equal hashcode as that for Object A 32, and so the object storage component 56 stores a copy of Object A 32 in the object system 40 and stores an association of a logical instance of Object A 32 with the physical copy in the object system 40. In this example, the object storage component 56 also stores the hashcode of Object A 32 along with the stored logical instance of Object A 32 for use in subsequent comparisons.

The processing of Object B 34 by the exemplary system 62 yields a different result. Object B 34 is also defined as a small object according to the data size threshold, so Object B 34 is also routed through the object storage component 56 of the exemplary system 62 for storing and indexing. As with Object A 32, the object storage component 56 computes a hashcode for Object B 34 and compares the hashcode (e.g., with reference to a hashtable associated with the object index 42) to the hashcodes of objects already stored in the object system 62, including the stored copy of Object A 32. However, in this case, the object storage component 56 discovers that Object F 46 shares the same hashcode as Object B 34. According to the object storage method embodied by the object storage component 56, the exemplary system 62 does not store a new copy of Object B 34, but instead indexes a logical instance of Object B 34 associated with the same physical object associated with the logical instance of Object F 46. Again, the object storage component 56 may also store the hashcode of Object B 34 along with the stored logical instance of Object B 34 for use in subsequent comparisons.

Object C 36 is handled differently as compared with the processing of Object A 32 and Object B 34, because Object C 36 comprises a large object (according to the data size threshold.) Object C 36 is therefore processed by the object segment storage component 58, which processes the object according to an object segment de-duplication storage and indexing method. In this exemplary system 62, the object segment storage component 58 identifies segments within Object C 36 according to the structure of the object. For example, if Object C 36 comprises an email archive, the object segments may comprise individual email messages; and if Object C 36 comprises an object collection (e.g., files stored in a compressed archive), the object segments may comprise the individual files stored in the archive; if Object C 36 comprises a database, the object segments may comprise the tables or records of the database; etc. Upon identifying the segments of the large object, the object segment storage component 58 computes the hashcode of respective segments and compares them to the hashcodes of segments already stored in the object system 40. The object segment storage component 58 discovers that segment 1 of Object C 36 is identical to segment 5 of Object G 48, and that segment 2 of Object C 38 is identical to segment 6 of Object H 50, but that segment 3 of Object C 38 has no identical segment in the object system 40. Accordingly, the object segment storage component 58 stores segment 3 in the object system 40, and then index Object C 38 in the object index 42 as a sequence of segment 5 of Object G 48, segment 6 of Object H 50, and the copy of segment 1 72 newly stored in the object system 40.

Object D 38 is also handled differently as compared with the process of Object A 32, Object B 34, and Object C 36, because Object D 38 is a large object but has no structure. Instead, Object D 38 is provided to the object chunk storage component 60, which processes large objects of unknown structure in relation to similar objects stored in the object system 40. The object chunk storage component 60 begins by identifying a trait set for Object D 38, which comprises some details about the object chosen in an arbitrary manner, but such that the similarity of trait sets between two objects is indicative of the similarity of the objects. The object chunk storage component 60 then compares the trait set of Object D 38 with the trait sets of the objects in the object system 40, i.e., Object I 52 and Object J 54 (also comprising large objects without structure.) The trait set comparison may be performed, e.g., through a bitwise comparison of the trait sets of the objects, such as XORing the two trait sets and counting the bits of value zero. The object chunk storage component 60 identifies no substantial similarity between the trait sets of Object D 38 and Object I 52 (with only 14 of the 32 bits matching), but very substantial similarity between the trait sets of Object D 38 and Object J 54 (with 31 of 32 bits matching.) The object chunk storage component 60 concludes that Object D 38 is very similar to Object J 54, and therefore computes a small data delta, comprising a list of the binary differences between the two objects. The object chunk storage component 60 then completes the storage and indexing of Object D 38 by storing the Object D/Object J data delta 74 in the object system 40 and indexing Object D 38 to both Object J 54 and the Object D/Object J data delta 74. The contents of Object D 38 may then be determined by reading Object J 54 and applying the Object D/Object J Data Delta 74 to produce the original contents of Object D 38.

The techniques discussed herein may be implemented with variations in many aspects, wherein some variations may present additional advantages and/or reduce disadvantages with respect to other variations of these and other techniques. Such variations may be compatible with various embodiments of the techniques, such as the exemplary method 10 of storing an object in an object system illustrated in FIG. 1 and the exemplary system 62 for storing an object in an object system illustrated in FIGS. 2 and 3, to confer such additional advantages and/or mitigate disadvantages of such embodiments.

A first aspect that may vary among implementations of these techniques relates to the scenario in which these technique may be utilized, and for which implementations may be configured. As a first example, the techniques may be applied to the storage of files, wherein the object system comprises a file store, the object index comprises a file system index, and the objects comprise files stored in the file store and indexed by the file system index. Alternatively, these techniques may be applied to the storage of data objects in memory, wherein the object system comprises a memory device (e.g., the main memory array of the computer system), the object index comprises a memory index, and the objects comprise data objects utilized by various programs and the operating system. It may be appreciated that these techniques involve some resource costs, such as extra CPU cycles and diminished speed in object accesses, due to the processing involved in identifying similar and identical objects and segments, and in ensuring that a change of one object does not unintentionally impact the contents of other objects that reference the changing object for de-duplication. Therefore, these techniques might be more advantageously used in the storage of objects that are not likely to change, and that are not likely to be accessed on an urgent basis. For instance, these techniques may be more advantageous in a backup archives, where a snapshot of the objects of a system (such as files on a hard disk drive) is stored for the unlikely event of a system crash. The complexity of the object storage and retrieval techniques may therefore be less significant than the total size of the backup archive, so the compression achieved by these techniques may be desirable while the reduced performance of object access is tolerable. However, these techniques may be configured in many ways to accommodate other scenarios by reducing some of these disadvantages. For example, if the performance of object retrieval is a significant factor, then objects referenced many times (e.g., a segment present in many large objects having structure) may be stored in a cached manner for faster access. Those of ordinary skill in the art may be able to address many object storage scenarios by utilizing and adapting the techniques discussed herein.

A second aspect that may vary among implementations of these techniques relates to the selection of a de-duplication technique for storing and indexing a particular object according to various parameters and heuristics. As a first example, the data size threshold, whereby an object may be designated as “small” if the data size is less than the data size threshold and “large” otherwise, may be arbitrarily chosen, or may be selected according to a heuristic (e.g., the mean or median object size in the object system), or may be computationally assessed through trial and error (e.g., by comparing the space savings achieved and resource costs expended, such as computation time, for applying the alternative de-duplication techniques to objects of different sizes.) For instance, a data size threshold of 128 kilobytes may be selected as a suitable threshold, or may be initially chosen and experimentally manipulated to determine whether additional space savings may be achieved.

As a second example of the aspect pertaining to the manner of choosing a de-duplication technique, the manner of identifying structure within large objects in order to choose and applying a suitable de-duplication technique may be performed in many ways. For instance, a segment of a large object of structure may comprise (e.g.) a database record structure of a database, an email structure of an email archive, a video frame of a video object, an audio frame of an audio object, or a file structure of a file set archive. The structures of the objects may also be identified by many techniques. As one example, the object may externally indicate the structure of the object; for instance, an object index may be configured to indicate the type of object as part of the object record (e.g., “object X is located here, and is an email archive.”) As a second example, the object may internally indicate the structure of the object; for instance, an object may contain a header that describes the type of object and the structure (e.g., an XML schema definition embedded in the object to define its structure.) As a third example, the computer system may be able to apply various analysis techniques and heuristics to identify the structure of an object, such as by locating repeating patterns within the data of the object. Those of ordinary skill in the art may be able to utilize many methods of identifying the structure of an object while implementing the techniques discussed herein.

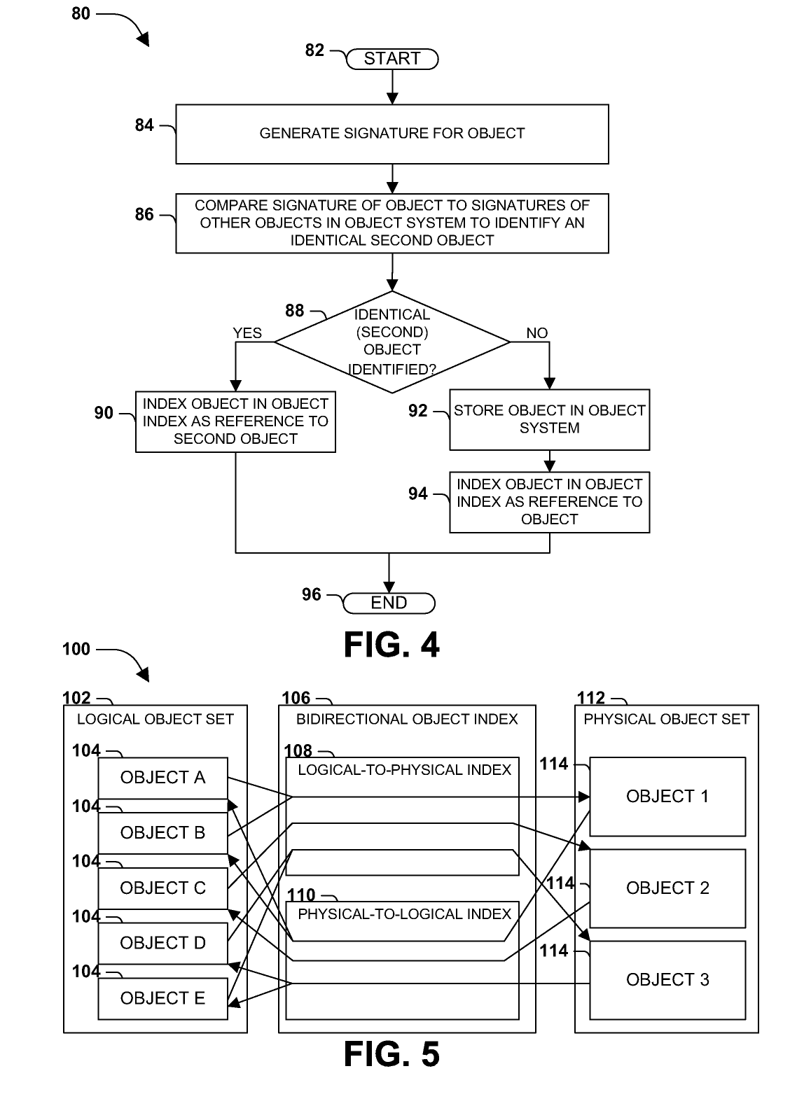

A third aspect that may vary among implementations of these techniques relates to the object de-duplication method used to store small objects. FIG. 4 illustrates one such object de-duplication method, comprising an exemplary method 80 of storing an object in an object system. A method of this nature might be utilized, e.g., while storing 18 small objects in the object system of FIG. 1, and/or embodied in the object storage component 56 of the exemplary system 62 of FIGS. 2-3. The exemplary method 80 of FIG. 4 begins at 82 and involves generating 84 a signature of the object. The signature comprises a value indicating the contents of the object, and may be compared with the signature of another object to determine whether the objects are identical. After generating 84 the signature of the object, the exemplary method 80 involves comparing 86 the signature of the object with the signatures of other objects in the object system. If a second object is identified that has a signature equal to the signature of the object, then the exemplary method 80 branches at 88 and involves indexing 90 the object in the object index as a reference to the second object. However, if the computer system fails to identify a second object having a signature equal to the signature of the object, the exemplary method 80 branches at 88 and involves storing 92 the object in the object system and indexing 94 the object in the object index as a reference to the object. Having stored the small object as either a de-duplicated reference to an identical object or as an ordinary storage of the copy of the object and a reference to the stored copy of the object, the exemplary method 80 achieves the storage of the small object, and so ends at 96.

Exemplary object de-duplication methods utilized herein (such as the exemplary method 80 of FIG. 4) may vary in many aspects. As one example, the signature of an object may be computed in many ways to produce an indicator of the contents of the object, such that any two objects having the same signature are very likely to contain the same data, whereas any two objects having different signature are very likely not to contain the same data. (In practice, a very small likelihood of a false positive or false negative association may exist, but the likelihood of such faults may be reduced to an acceptably small incidence.) One technique for generating such a signature is to compute a hashcode for the object according to a hash function. Many hash functions may be available and suitable for this task, such as a Secure Hash Algorithm (e.g., SHA-0 or SHA-1) or a Message-Digest algorithm (e.g., MD5.) Moreover, some hash functions may present additional advantages for this task as compared with other hash functions, such as fast computation, reduced incidence of false positives and/or negatives, and cryptographic hash computations that reduce the possibility that an object may be engineered to have the same hashcode as another object but different contents, thereby eliciting a false positive result from the comparison. Those of ordinary skill in the art may be able to choose among many available hash functions, or to derive a new hash function having additional advantages or reducing disadvantages, while implementing the techniques discussed herein.

As a second variation of object de-duplication methods, the object index may be configured to facilitate object de-duplication. As a first example, the object index may be configured to store the signatures of indexed objects, and the indexing of an object may comprise storing the signature of the object in the object index. The signatures may be stored (e.g.) in a hashtable associated with the object index, which enables a quick comparison of a new signature to previously stored signatures to determine whether any object shares the same signature as a new object. As a second example, the object index may also indicate the logical objects that reference a physical copy of an object in the object system. When a first logical object is determined to be identical to a second logical object, the first logical object is indexed to the same physical object as the second logical object. If the physical object subsequently changes (e.g., is updated, changes size, is relocated during defragmentation or memory compaction, etc.), then updating the references of the logical objects to the physical object may involve a full scan of the object index, which may be lengthy in the case of large object systems hosting millions of objects. Instead, a bidirectional object index may be implemented that not only relates logical objects to physical objects on storage devices, but also relates physical objects back to logical objects, in order to facilitate determinations of which logical objects reference a particular physical object. Other variations of these and other aspects of object indices may be devised by those of ordinary skill in the art while implementing object de-duplication methods in accordance with the techniques discussed herein.

FIG. 5 illustrates an example 100 of an object index configured in this manner, wherein a logical object set 102 is associated with a physical object set 112 through a bidirectional object index 106. The bidirectional object index comprises a logical-to-physical index 108, wherein various logical objects 104 of the logical object set 102 may be associated with physical objects 114 in the physical object set 112 in a many-to-one relationship. For instance, upon attempting to store Object A in the object system, an object de-duplication method (such as the exemplary method 80 of FIG. 4) may determine that Object A is Object A is identical to Object B, represented on the physical medium as Object 1. The object de-duplication method may therefore store Object A by indexing it the logical-to-physical index 108 as a reference to Object 1, thereby forming a two-to-one relationship (i.e., both logical Object A and logical Object B referencing physical Object 1) in the bidirectional object index 106. Additionally, the bidirectional object index 106 comprises a physical-to-logical index 110, wherein physical objects in the physical object set 112 may be related back to logical objects in the logical object set 102. Thus, upon storing Object A in the object system, the bidirectional object index also indexes Object A in the physical-to-logical index 110 as one of two logical objects associated with Object 1. The bidirectional nature of the bidirectional object index 106 may therefore facilitate various operations on the physical objects stored in the object system by reducing inefficient scanning of the object index for references to a particular physical object.

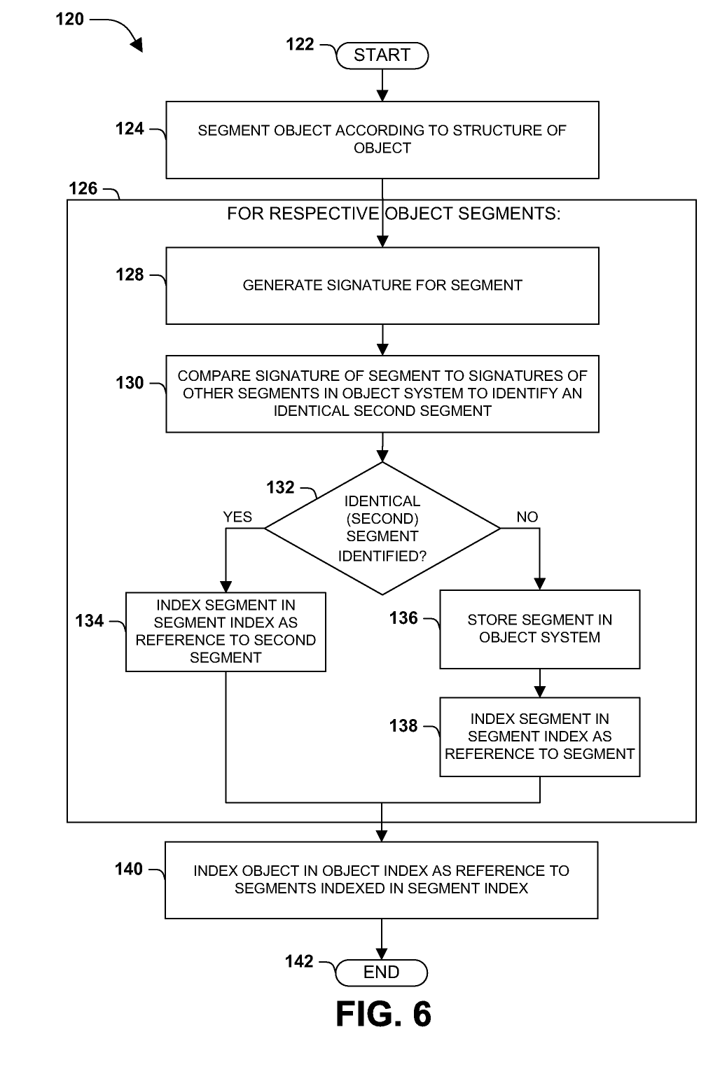

A fourth aspect that may vary among implementations of these techniques relates to the object segment de-duplication method used to store large objects that have structure. The object segment de-duplication may resemble the object de-duplication method, but may be performed on the segments of an object (identified according to the structure of the object) rather than on the object as a single entity. FIG. 6 illustrates one such object segment de-duplication method, comprising an exemplary method 120 of storing the segments of an object of structure in an object system. A method of this nature might be utilized, e.g., while storing 20 large objects of structure in the object system of FIG. 1, and/or embodied in the object segment storage component 58 of the exemplary system 62 of FIGS. 2-3.

The exemplary method 120 of FIG. 6 begins at 122 and involves segmenting 124 the object according to the structure of the object. For example, if the object is identified as an email archive containing email messages, then the object may be segmented according to the structure of an email message in the email archive into a set of object segments representing individual email messages. The exemplary method 120 of FIG. 6 also involves processing 126 respective segments of the object in the following manner. For each segment of the object, the exemplary method 120 involves generating 128 a signature of the segment. Just as in the object de-duplication method illustrated in FIG. 4, the signature of a segment comprises a value indicating the contents of the segment, which may be compared with the signature of another segment to determine whether the segments are identical. After generating 128 the signature of the segment, the exemplary method 120 involves comparing 130 the signature of the segment with the signatures of other segments in the object system. If a second segment is identified that has a signature equal to the signature of the segment, then the exemplary method 120 branches at 132 and involves indexing 134 the segment in the segment index as a reference to the second segment. However, if the computer system fails to identify a second segment having a signature equal to the signature of the segment, the exemplary method 120 branches at 132 and involves storing 136 the segment in the object system and indexing 138 the segment in the segment index as a reference to the segment. After processing 126 the respective segments of the object, the exemplary method 120 of FIG. 6 involves indexing 140 the object in the object system as a reference to the segments indexed in the segment index. Having stored each segment of the object as either a de-duplicated reference to an identical segment or as an ordinary storage of the copy of the segment and a reference to the stored copy of the segment, and having indexed the object according to the indices of the stored segments, the exemplary method 120 achieves the storage of the large object of structure, and so ends at 142.

Exemplary object segment de-duplication methods utilized herein (such as the exemplary method 120 of FIG. 6) may vary in many aspects. As one example, similarly to the computation of signatures in object de-duplication methods, the signatures of segments in object segment de-duplication methods may be computed in many ways, such as according to one of many available hash functions having various features. As a second example, and again similar to the configuration of the object index utilized in the indexing of objects according to object de-duplication methods, the segment index may be configured to store the signatures of indexed segments, and the indexing of a segment may comprise storing the signature of the segment in the segment index (e.g., in a hashtable associated with the segment index and provided to facilitate the detection of equal signatures of identical objects in the object system.) As a third example, the segment index may comprise a bidirectional segment index, which, similarly to the bidirectional object index 106 illustrated in the example 100 of FIG. 5, bidirectionally relates the logical segments of various large objects with the physical segments stored on various storage devices, and thereby facilitates operations on the physical devices (such as updating the contents of a segment, defragmentation, and memory compaction) that involve referencing and updating the logical references to a particular physical segment.

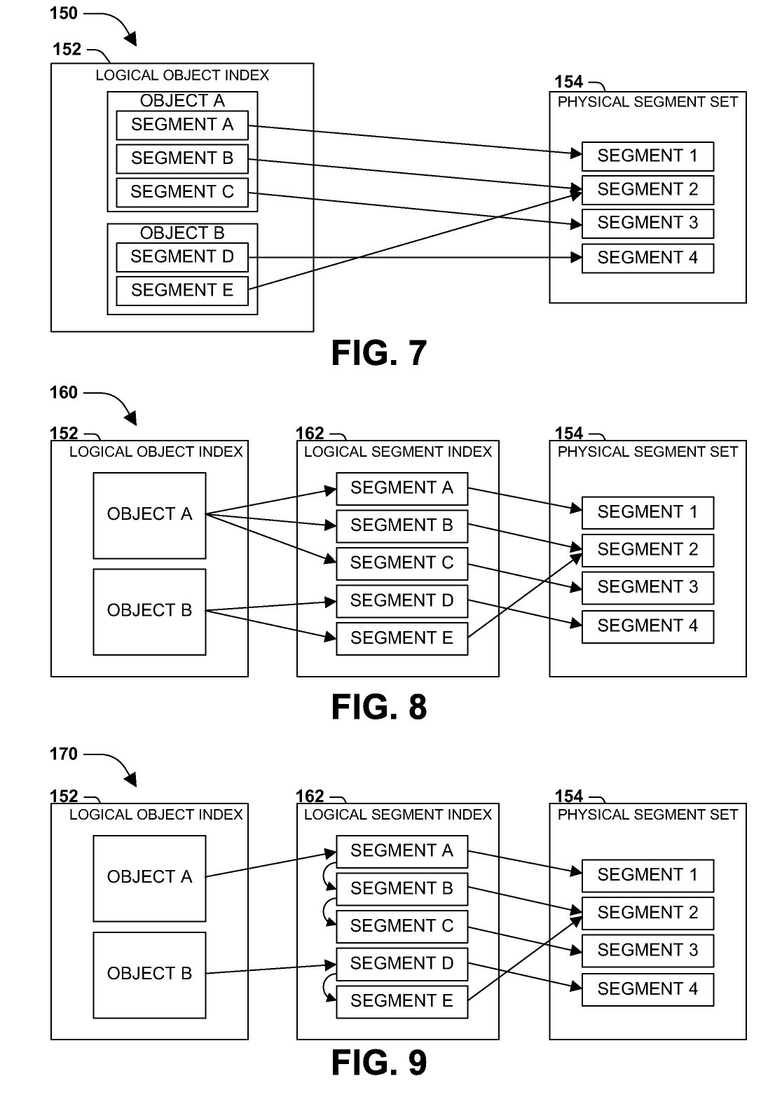

A fourth exemplary variation of object segment de-duplication methods involves the implementation of the object segment index within the object index, or as a separate index containing references to the segments of objects indexed in the object index. FIGS. 7-8 illustrate three variant implementations of the segment index as a subset of the object index or as a separate index to which the large, structured objects referenced in the object index may be related. FIG. 7 presents a first example 150 wherein two objects represented in a logical object index 152 comprise large objects with segments identified according to the structure of the object, wherein the objects are represented in the logical object index 152 as a series of references to segments stored in the physical segment set 154. FIG. 8 presents a second example 160 wherein the same two objects, again comprising large objects with segments identified according to the structure of the object, are represented in the logical object index 152 as references to a set of segments in a separate logical segment index 162, which then relates the segments to the physical segment set 154. FIG. 9 presents a third example 170 wherein the logical object index 152 might be configured to store each object in the logical object index 152 reference only the first segment of the object in the logical segment index 162, and the records of segments in the logical segment index 162 reference the next segment in the object. The first example 152 may have an advantage of some space savings as compared with the two separate structures (e.g., two separate hashtables) of FIGS. 8-9, while the latter examples may reduce some of the complexity of the logical object index 152 as compared with the configuration of the logical object index 152 in FIG. 7 that is capable of storing lists of references for segmented objects. Those of ordinary skill in the art may be able to devise many techniques for indexing objects and segments thereof while implementing an object segment de-duplication method in accordance with the techniques discussed herein.

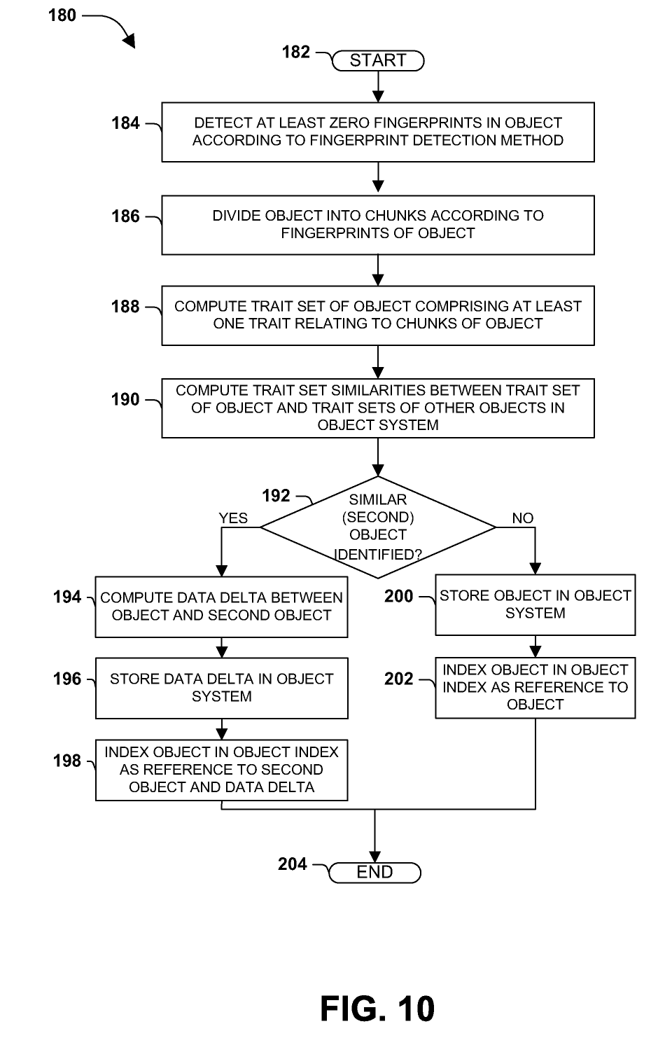

A fifth aspect that may vary among implementations of these techniques relates to the object chunk de-duplication method used to store large objects that do not have structure. The object chunk de-duplication is different from the object de-duplication method and the object segment de-duplication method, because rather than attempting to locate a completely identical second object in the object system, the object chunk de-duplication method attempts to find a similar second object, and to store the new object as a reference to the second object plus a list of the differences between the two objects, referred to herein as a data delta. By applying the data delta to the data comprising the second object, the computer system may derive the contents of the new object, without having to store the duplicate contents of the new object in the object system. This technique therefore economizes the storage of large objects that may be similar, but may not be completely identical. FIG. 10 illustrates one such object chunk de-duplication method, comprising an exemplary method 180 of storing an object that does not have structure in an object system. A method of this nature might be utilized, e.g., while storing 22 large objects that have no structure in the object system of FIG. 1, and/or embodied in the object chunk storage component 60 of the exemplary system 62 of FIGS. 2-3.

The exemplary method 180 of FIG. 10 begins at 182 and involves detecting 184 at least zero fingerprints in the object according to a fingerprint detection method. The fingerprint detection method is configured to scan the contents of the object and locate particular locations in the object where the object may be divided into chunks. The exemplary method 180 also involves dividing 184 the object into chunks according to the fingerprints of the object, e.g., by defining chunks of the object with the object fingerprints designated as chunk boundaries. The exemplary method 180 also involves computing 186 a trait set of the object comprising at least one trait relating to the chunks of the object. The traits are derived from the contents of the chunks of the object in such a manner that if a first trait set is computed for a first object and a second trait set is computed for a second object, the similarity of the trait sets approximates the similarity of the contents of the first object to the contents of the second object.

Once a trait set has been computed for the object to be stored, the exemplary method 180 involves computing trait set similarities between the trait set of the object and the trait sets of other objects in the object system. The comparison of two trait sets yields an approximate degree of similarity, e.g., the percent of bits in the first trait set that equal corresponding bits in the second trait set. The degree of similarity is then compared to a similarity threshold, e.g., a 90% similarity between the bits of the respective trait sets. Based on this comparison, an object may be identified that is suitably similar to the new object to support a differencing-based de-duplication technique. (If multiple objects having an acceptable trait set similarities are identified, then the exemplary method 80 may choose among them; e.g., it may be advantageous to choose the trait set similarity having the highest trait set similarity computation.) If an object is identified having a trait set similarity of at least the similarity threshold, then the exemplary method 180 branches at 192 and involves computing 194 a data delta between the object and the second object, e.g., by performing a diff operation that performs a bitwise comparison of the objects and produces a list of differences between the binary data contents of the objects. The exemplary method 180 then involves storing 196 the data delta in the object system and indexing 198 the object in the object index as a reference to the second object and the data delta. However, if no second object is identified having a trait set similarity greater than the similarity threshold, then the exemplary method 180 branches at 192 and involves storing 200 the object in the object in the object system and indexing 202 the object in the object index as a reference to the object (i.e., by storing a full copy of the object in the object system.) Upon either storing the object as a reference to a similar second object and a data delta, or as a reference to a full copy of the object, the exemplary method 180 achieves the storage of the large object of no structure in the object system in a manner that permits de-duplication with respect to similar objects, and so ends at 204.

Exemplary object chunk de-duplication methods utilized herein (such as the exemplary method 180 of FIG. 610 may vary in many aspects. As a first example, detecting fingerprints in the object may be performed according to many techniques. The fingerprint identification of the object may be advantageously selected or devised for an object chunk de-duplication method to promote the equivalent identification of chunks that may serve as dividers between similar sections of data, such that if two objects share an identical section of data, these sections of data in the objects may be equivalently chunked, which may promote similarities between the trait sets of the objects. It may be noted that an advantageously devised fingerprint technique may identify fingerprints such that chunks occur at least somewhat often in most objects, e.g., by choosing an arbitrary value that may be located at statistically frequent intervals in a random data set, whereby the chunks of a typical object may be somewhat numerous and of similar size.

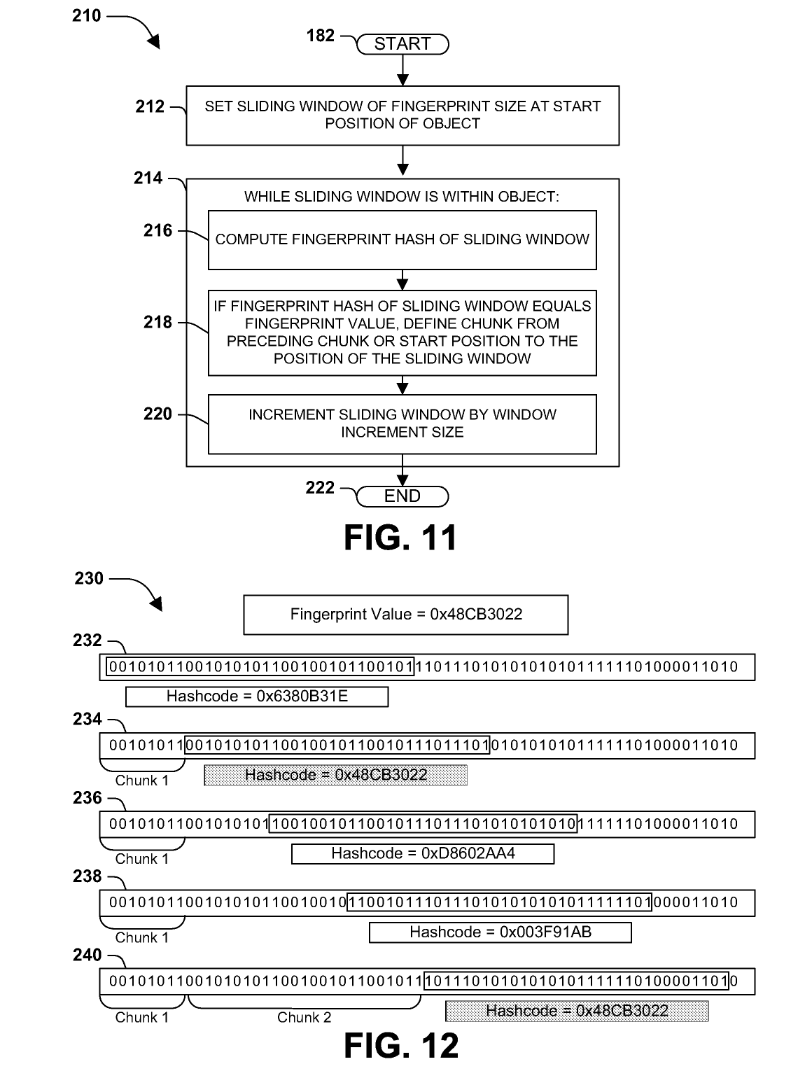

FIG. 11 illustrates an exemplary method 210 of detecting fingerprints in an object. More specifically, the exemplary method 210 involves the detection of fingerprints of a fingerprint size, and the fingerprints may be detected according to a fingerprint hash to match a fingerprint value. For instance, the exemplary method 210 may choose a random fingerprint value and a 32-bit fingerprint size. The exemplary method may then endeavor to locate 32-bit blocks of data in the object that, upon processing by the fingerprint hash function, produce a value equaling the fingerprint value. In performing this task, the exemplary method 210 begins at 210 and involves setting 212 a sliding window of the fingerprint size at a start position of the object. The window therefore begins at the start window and initially references a block of data of the fingerprint size (e.g., the first 32 bits of the object.) The exemplary method then involves an iteration 214 for processing respective blocks of data in the object exposed by the sliding window in the following manner. While the sliding window is within the object (i.e., while start index of the sliding window plus the fingerprint size are not greater than the total size of the object), the exemplary method 210 involves computing 216 the fingerprint hash of the sliding window. If the fingerprint hash of the sliding window equals the fingerprint value, the exemplary method 210 involves defining 218 a chunk from one of the position of a preceding chunk and the start position to the position of the sliding window (i.e., defining a chunk from the end of the previous chunk, or from the beginning of the object for the first chunk, to the current start index of the sliding window.) Whether or not a fingerprint is detected, the exemplary method 210 involves incrementing 220 the sliding window by a window increment size, e.g., by eight bits. The iteration 214 continues until the sliding window no longer remains in the object. Having iteratively scanned the object and detected zero or more fingerprints in the object, the exemplary method 210 achieves the identification of fingerprints in the object, upon which the exemplary method 210 ends at 222.

FIG. 12 illustrates an exemplary application 230 of a fingerprint detection method, such as the exemplary method 210 of FIG. 11, to an object data set in order to detect fingerprints that define chunks of the object. The exemplary application 230 endeavors to locate sections of data in the data set having a hashcode matching 0x48CB3022. The exemplary application 230 begins in a first state 232, wherein the sliding window is positioned at the start position of the object and sized according to the fingerprint size of 32 bits. The hashcode for the data exposed by the sliding window is processed by a hashcode function, which results in a hashcode of 0x6380B31E, which does not equal the fingerprint value. The sliding window is then moved according to a window increment size of eight bits, resulting in the positioning of the window in the second state 234. The hashcode of this block of data is also computed, and results in a hashcode of 0x48CB3022 matching the fingerprint value. Accordingly, the fingerprint detection method identifies a fingerprint at this position in the object, and a first object chunk may be defined from the start of the object to the index of the sliding window. The sliding window is then moved again by eight bits, resulting in the third state 236, etc. Eventually, in the fifth state 240, the sliding window identifies a second block of data having a hashcode of 0x48CB3022, and declares another fingerprint that begins at the end of the first chunk and continues through the current position of the sliding window. The processing of the object may continue by incrementing the sliding window across the length of the object to detect fingerprints throughout the object.

The particular details of fingerprint detection functions (such as the exemplary method 210 of FIG. 11, illustrated in the exemplary application 230 of FIG. 12) may be selected in various ways. As one example, the fingerprint hash may comprise a Rabin fingerprint hash, which is a detailed algorithm known to those of ordinary skill in the art. The Rabin fingerprint hash is useful in circumstances such as this because when a hash is computed for a first section of data, a second hash may be computed for a second section of data that overlaps the first section of data in a comparatively quick manner (i.e., by re-using the portion of the hash pertaining to the overlapping section.) As a second example, the fingerprint value, the fingerprint size, and the window increment size may be chosen in many ways based on the nature of the fingerprint hash and the data of the objects to which the fingerprint detection method is applied. In the example of FIG. 12, the fingerprint value comprises a random value associated with the object index, such that the same fingerprint value is used to determine chunks in all objects of the object system; the fingerprint size is chosen as 32 bits; and the increment size is chosen as eight bits. Those of ordinary skill in the art may choose many such details in view of various fingerprint detection methods and different object system wherein such selected fingerprint detection methods are utilized while implementing the techniques discussed herein.

A second example of a variation among object chunk de-duplication methods utilized herein relates to the trait sets computed with respect to various objects and compared to determine the similarity of the objects. The trait set computation and evaluation are more complicated than the hashing techniques utilized in other de-duplication methods, because the trait sets do not only indicate identity or non-identity, but similarity. For instance, two large files that differ only by one bit may have completely different hashcodes (as they are not identical), but have identical or extremely similar trait sets. The mathematical analysis techniques in the computation of trait sets are therefore somewhat different than those for hashcode computation.

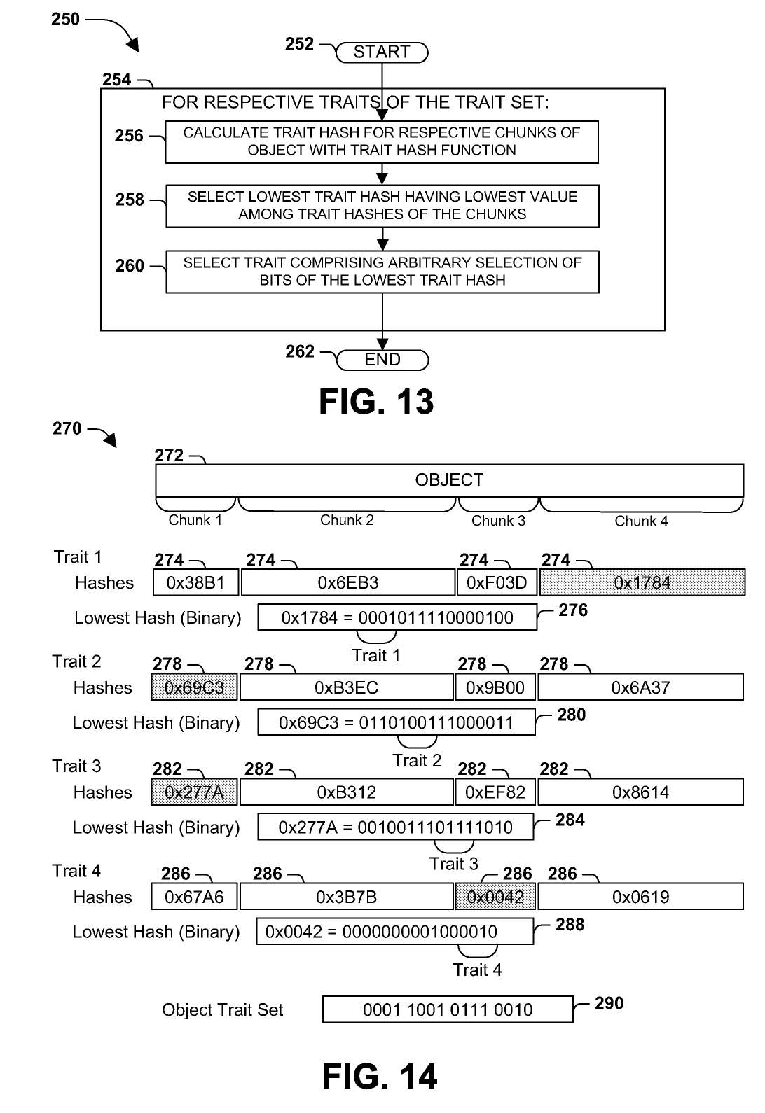

FIG. 13 illustrates one technique for computing such trait sets, comprising an exemplary method 250 of computing traits of a trait set for an object, wherein respective traits are associated with a trait hash function. For instance, a trait set may comprise three traits computed according to a first hash function, a second hash function, and a third hash function. In computing a trait set of this nature for an object, the exemplary method 250 begins at 252 and involves an iteration 254 for respective traits of the trait set. For each such trait, the exemplary method 250 involves calculating 256 a trait hash for respective chunks of the object with the trait hash function, and selecting 258 a lowest trait hash having a lowest value among the trait hashes of the chunks. In this manner, the exemplary method 250 identifies the lowest hashcode for the chunks of the object according to the hash function for a particular trait. When the lowest trait hash has been selected, the exemplary method 250 involves selecting 260 the trait comprising an arbitrary selection of bits of the lowest trait hash. For instance, a certain range of bits (e.g., the first three bits) may be selected from the lowest trait hash as the respective trait of the object for the current iteration. The exemplary method 250 similarly computes the other traits of the trait set (using the other hash functions associated therewith), and the selected traits together comprise the trait set for the object.

It may be appreciated that the traits are derived from the content of the object in a manner such as the exemplary method 250 of FIG. 13 such that the trait sets of two identical objects (having been divided into identical chunks according to an object chunking method, and processed through the same trait computation method) are also identical. Moreover, as the contents of a first object gradually diverge from the contents of a second object, the chunking and trait computations of the various chunks also produce increasingly different results according to a smooth gradient. Accordingly, the trait sets for two objects generally share a bitwise similarity that is proportional to the similarity of the contents of the two objects. It may also be appreciated that, because a fixed-size trait is generated for an object irrespective of the number or sizes of chunks contained therein, objects may be compared in this manner even if the objects are not of equal size. For instance, if a first object comprises an identical copy of the first 90% of a second object, the trait sets of the objects are likely to share an approximate 90% similarity.

The computation of a trait set as a set of traits may also be devised in many variations in some aspects. As one example, the number of traits in a trait set may be arbitrarily chosen, as may the size of a particular trait. For example, a trait set may comprise eight traits having four bits for each trait. These selections may be advantageous because the total number of bit in the trait set (32 bits) may cover the range of a 32-bit value generated by a trait hash function. The total number of bits contained in a trait set may be increased to produce a more accurate measurement of the similarities of two large objects, but an increasing size of the trait sets may also involve more computation (e.g., more iterations of the exemplary method 250 of FIG. 13) and greater storage space for storing larger computed trait sets. As a second example, the bits of the lowest trait hash may be selected in any arbitrary manner, so long as the bits are similarly selected for a particular trait for all objects. As one example, the bits comprising a trait may be selected according to the mathematical formula:

Tₜ=select_{(t-1)b . . . tb-1}Hₜ

wherein:
t represents a trait number 1 . . . n among n traits;
Hₜ represents the lowest trait hash among the trait hashes of
   the chunks computed according to trait hash function t;
b represents the bit size of a trait, wherein nb=size(Hₜ); and
Tₜ represents the trait computed for trait number t.
   For an exemplary trait set comprising four traits of four bits, each trait associated with a (different) 16-bit hashcode, the exemplary method results in the trait set comprising bits 0-3 of the lowest trait hash computed by the first trait hash function, bits 4-7 of the lowest trait hash computed by the second trait hash function, bits 8-11 of the lowest trait hash computed by the third trait hash function, and bits 12-15 of the lowest trait hash computed by the fourth trait hash function. This configuration may be desirable because the bits comprising the trait set are selected from the complete range of bits generated by the hash functions, which may serve to reduce the impact of mathematical flaws in the statistically random hashcodes produced by the hash functions.

FIG. 12 illustrates an exemplary application 270 of the exemplary method 250 of FIG. 11 to an arbitrary object resulting in the computation of a trait set for the object reflecting the contents of the object. The exemplary application 270 involves the computation of a trait set involving four traits for an object 272 comprising four chunks. The first trait is computed by applying a first hash function to each of the chunks of the object 272 to generate respective first trait hashes 274. Among these first trait hashes 274, the lowest first trait hash 276 is selected, and according to the bit selection mathematical formula, bits 0-3 of the lowest first trait hash 276 are selected for the first trait. The second trait is similarly computed by applying a second hash function to each of the chunks of the object 272 to generate respective second trait hashes 278, the lowest second trait hash 280 is selected from among the second trait hashes 278, and bit 4-7 are selected from the lowest second trait hash 280 to form the second trait. A similar computation is performed to generate the third and fourth traits, resulting in an object trait set 290 comprising the four 4-bit traits computed in this manner. Those of ordinary skill in the art may be able to devise many techniques for computing trait sets from objects in an object set while implementing an object chunk de-duplication method as described herein.

A third example of a variation among object chunk de-duplication methods utilized herein relates to the manner of utilizing the trait sets computed for various objects. As one example, the trait sets of two objects may be compared by various techniques, such as by a bitwise comparison (e.g., an XOR operation followed by a counting of 0's in the resulting XOR as a measurement of bitwise similarity.) As a second example, the trait set similarity computation may be compared with a similarity threshold that may be selected in many ways, e.g., a similarity threshold of 0.9 may be chosen to indicate that two objects are sufficiently similar for object chunk de-duplication if the trait sets of the objects share a 90% similarity. The similarity threshold may be chosen in various ways, e.g., by arbitrary selection, by heuristics or analysis, or by incremental trial-and-error adjustment. As a third example, the trait sets may be stored in various ways. For instance, the object index may be configured to store the trait sets of the objects, and the indexing of an object may comprise storing the trait set of the object in the object index. The trait sets computed for the various objects may be utilized in many ways in object chunk de-duplication methods by those of ordinary skill in the art while implementing the techniques discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it may be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of storing an object of an object system having an object index, the method comprising:
if the size of the object is below a data size threshold, storing the object in the object system indexed according to an object de-duplication method; and
if the size of the object is not below the data size threshold:
if the object comprises a structure, storing the object in the object system indexed according to an object segment de-duplication method based on at least one object segment defined by the structure of the object; and
if the object does not comprise a structure, storing the object in the object system indexed according to an object chunk de-duplication method based on at least one arbitrarily defined object chunk.

2. The method of claim 1, the object system comprising a file store, the object index comprising a file system index, and the objects comprising files stored in the file store and indexed by the file system index.

3. The method of claim 1, the structure of the object identified as one of:
a database record structure of a database;
an email structure of an email archive;
a video frame of a video object;
an audio frame of an audio object; and
a file structure of a file set archive.

4. The method of claim 1, the data size threshold comprising 128 kilobytes.

5. The method of claim 1, the object de-duplication method comprising:
generating a signature of the object;
comparing the signature of the object with the signatures of other objects in the object system;
upon identifying a second object having a signature equal to the signature of the object, indexing the object in the object index as a reference to the second object; and
upon failing to identify a second object having a signature equal to the signature of the object:
storing the object in the object system, and
indexing the object in the object index as a reference to the object.

6. The method of claim 5:
the object index configured to store the signatures of indexed objects, and
the indexing comprising:
storing the signature of the object in the object index.

7. The method of claim 1, the object index having a segment index, and the object segment de-duplication method comprising:
segmenting the object according to the structure of the object;
for respective segments of the object:
generating a signature of the segment;
comparing the signature of the segment with the signatures of other segments in the object system;
upon identifying a second segment having a signature equal to the signature of the segment, indexing the segment in the segment index as a reference to the second segment; and
upon failing to identify a second segment having a signature equal to the signature of the segment:
storing the segment in the object system, and
indexing the segment in the segment index as a reference to the segment; and
indexing the object in the object index as a reference to the segments of the object indexed in the segment index.

8. The method of claim 7:
the segment index configured to store the signatures of indexed segments, and
the indexing of segments comprising:
storing the signature of the segment in the segment index.

9. The method of claim 1, the object chunk de-duplication method comprising:
detecting at least zero fingerprints in the object according to a fingerprint detection method;
dividing the object into chunks according to the fingerprints of the object;
computing a trait set of the object comprising at least one trait relating to the chunks of the object;
computing trait set similarities between the trait set of the object and the trait sets of other objects in the object system;
upon identifying a second object having a trait set similarity greater than a similarity threshold:
computing a data delta between the object and the second object, and
storing the data delta in the object system, and
indexing the object in the object index as a reference to the second object and the data delta; and
upon failing to identify a second object having a trait set similarity greater than the similarity threshold:
storing the object in the object system, and
indexing the object in the object index as a reference to the object.

10. The method of claim 9, the fingerprint detection method comprising a detection of fingerprints in the object of a fingerprint size and computed according to a fingerprint hash to match a fingerprint value, the detection comprising:
setting a sliding window of the fingerprint size at a start position of the object; and
while the sliding window is within the object:
computing the fingerprint hash of the sliding window;
if the fingerprint hash of the sliding window equals the fingerprint value, defining a chunk from one of the position of a preceding chunk and the start position to the position of the sliding window; and
incrementing the sliding window by a window increment size.

11. The method of claim 10:
the fingerprint hash comprising a Rabin fingerprint hash;
the fingerprint value comprising a random value associated with the object index;
the fingerprint size comprising 32 bits; and
the window increment size comprising eight bits.

12. The method of claim 9:
respective traits of the trait sets associated with a trait hash function, and
the method comprising:
for respective traits of the trait set:
calculating a trait hash for respective chunks of the object with the trait hash function;
selecting a lowest trait hash having a lowest value among the trait hashes of the chunks; and
selecting the trait comprising an arbitrary selection of bits of the lowest trait hash.

13. The method of claim 12, respective traits computed according to the mathematical formula:
Tₜ=select_{(t-1)b . . . tb-1}Hₜ
wherein:
t represents a trait number 1 . . . n among n traits;
Hₜ represents the lowest trait hash among the trait hashes of the chunks computed according to trait hash function t;
b represents the bit size of a trait, wherein nb=size(Hₜ); and
Tₜ represents the trait computed for trait number t.

14. The method of claim 9:
the trait set similarity computing comprising a bitwise comparison of the trait set of the object and the trait sets of other objects in the object system, and
the similarity threshold comprising 0.9.

15. The method of claim 9:
the object index configured to store the trait sets of the objects, and
the indexing comprising:
storing the trait set of the object in the object index.

16. A system for storing an object of an object system having an object index, the system comprising:
an object storage component configured to store objects having a size below a data size threshold in the object system indexed according to an object de-duplication method;
an object segment storage component configured to store objects of a structure and having a size not below a data size threshold in the object system indexed according to an object segment de-duplication method based on at least one object segment defined by the structure of the object; and
an object chunk storage component configured to store objects without structure and having a size not below the data size threshold in the object system indexed according to an object chunk de-duplication method based on at least one arbitrarily defined object chunk.

17. The system of claim 16, the object de-duplication method of the object storage component comprising:
generating a signature of the object;
comparing the signature of the object with the signatures of other objects in the object system;
upon identifying a second object having a signature equal to the signature of the object, indexing the object in the object index as a reference to the second object; and
upon failing to identify a second object having a signature equal to the signature of the object:
storing the object in the object system, and
indexing the object in the object index as a reference to the object.

18. The system of claim 16, the object index having a segment index, and the object segment de-duplication method of the object segment storage component comprising:
segmenting the object according to the structure of the object;
for respective segments of the object:
generating a signature of the segment;
comparing the signature of the segment with the signatures of other segments in the object system;
upon identifying a second segment having a signature equal to the signature of the segment, indexing the segment in the segment index as a reference to the second segment; and
upon failing to identify a second segment having a signature equal to the signature of the segment:
storing the segment in the object system, and
indexing the segment in the segment index as a reference to the segment; and
indexing the object in the object index as a reference to the segments of the object indexed in the segment index.

19. The system of claim 16, the object chunk de-duplication method of the object chunk storage component comprising:
detecting at least zero fingerprints in the object according to a fingerprint detection method;
dividing the object into chunks according to the fingerprints of the object;
computing a trait set of the object comprising at least one trait relating to the chunks of the object;
computing trait set similarities between the trait set of the object and the trait sets of other objects in the object system;
upon identifying a second object having a trait set similarity greater than a similarity threshold:
computing a data delta between the object and the second object, and
storing the data delta in the object system, and
indexing the object in the object index as a reference to the second object and the data delta; and
upon failing to identify a second object having a trait set similarity greater than the similarity threshold:
storing the object in the object system, and
indexing the object in the object index as a reference to the object.

20. A method of storing an object comprising files of an object system having an object index configured to store signatures and trait sets of respective objects, the object index having a segment index configured to store signatures of respective segments, and the method comprising:
if the size of the object is below a data size threshold of 128 kilobytes, storing the object in the object system indexed according to an object de-duplication method comprising:
generating a signature of the object;
comparing the signature of the object with the signatures of other objects in the object system;
upon identifying a second object having a signature equal to the signature of the object, indexing the object in the object index as a reference to the second object;
upon failing to identify a second object having a signature equal to the signature of the object:
storing the object in the object system, and
indexing the object in the object index as a reference to the object; and
storing the signature of the object in the object index; and
if the size of the object is not below the data size threshold:
if the object comprises a structure, storing the object in the object system indexed according to an object segment de-duplication method based on at least one object segment defined by the structure of the object, the method comprising:
segmenting the object according to the structure of the object;
for respective segments of the object:
generating a signature of the segment;
comparing the signature of the segment with the signatures of other segments in the object system;
upon identifying a second segment having a signature equal to the signature of the segment, indexing the segment in the segment index as a reference to the second segment;
upon failing to identify a second segment having a signature equal to the signature of the segment:
storing the segment in the object system, and
indexing the segment in the segment index as a reference to the segment;
indexing the object in the object index as a reference to the segments of the object indexed in the segment index; and
storing the signature of the segment in the segment index; and
if the object does not comprise a structure, storing the object in the object system indexed according to an object chunk de-duplication method based on at least one arbitrarily defined object chunk, the method comprising:
detecting at least zero fingerprints in the object of a fingerprint size of 32 bits and matching a fingerprint value comprising a random value associated with the object index, the fingerprints computed according to a fingerprint detection method comprising:
setting a sliding window of the fingerprint size at a start position of the object; and
while the sliding window is within the object:
computing the Rabin fingerprint hash of the sliding window;
if the Rabin fingerprint hash of the sliding window equals the fingerprint value, defining a chunk from one of the position of a preceding chunk and the start position to the position of the sliding window; and
incrementing the sliding window by a window increment size of eight bits;
dividing the object into chunks according to the fingerprints of the object;
computing a trait set of the object comprising at least one trait relating to the chunks of the object, respective traits associated with a trait hash function, and the computing comprising:
for respective traits of the trait set:
calculating a trait hash for respective chunks of the object with the trait hash function;
selecting a lowest trait hash having a lowest value among the trait hashes of the chunks; and
selecting the trait comprising an arbitrary selection of bits of the lowest trait hash according to the mathematical formula:
Tₜ=select_{(t-1)b . . . tb-1}Hₜ
wherein:
t represents a trait number 1 . . . n among n traits;
Hₜ represents the lowest trait hash among the trait hashes of the chunks computed according to trait hash function t;
b represents the bit size of a trait, wherein nb=size(Hₜ); and
Tₜ represents the trait computed for trait number t;
computing trait set similarities between the trait set of the object and the trait sets of other objects in the object system;
upon identifying a second object having a trait set similarity greater than a similarity threshold:
computing a data delta between the object and the second object, and
storing the data delta in the object system, and
indexing the object in the object index as a reference to the second object and the data delta;
upon failing to identify a second object having a trait set similarity greater than the similarity threshold:
storing the object in the object system, and
indexing the object in the object index as a reference to the object; and
storing the trait set of the object in the object index.
